(19) United States
(12) Patent Application Publication
(10) Pub. No.: US 2022/0076217 A1
(43) Pub. Date: Mar. 10, 2022

(54) Decentralized Token Swapping Method with Low Slippage Point and High Liquidity

(71) Applicant: Jinan Zhishu Information and Technology Co., Ltd., Jinan (CN)

(72) Inventor: Lin Han, London (CA)

(21) Appl. No.: 17/467,359

(22) Filed: Sep. 6, 2021

(30) Foreign Application Priority Data
Sep. 4, 2020 (CN) 202010925619.9

(51) Int. Cl. G06Q 20/06; G06Q 20/38; G06Q 40/02; G06Q 50/18

(52) U.S. Cl. CPC G06Q 20/0658; G06Q 20/38215; G06Q 50/18; G06Q 40/02; G06Q 20/3827

(57) ABSTRACT

The present invention discloses a decentralized token swapping method with low slippage point and high liquidity. The present invention relates to the technical field of decentralized token exchanging, specifically, providing liquidity to a liquidity pool by a liquidity provider, depositing a X token and a Y token into the liquidity pool in an equal value ratio in a mortgage mode; providing liquidity to X maker pool and Y Maker Pool by X maker and Y maker independently. In the present invention, a Taker determines to swap from the liquidity pool or the maker pools based on a random number. The present invention can effectively reduce the swapping slippage points: if the leverage rate is n, then the slippage point can be reduced to 1/n of the Uniswap mode, and more demand can be provided. For instance, users who plan to sell one asset for another over a period of time can provide liquidity, rather than only rely on users in an equal ratio mortgage to provide liquidity.

### CROSS-REFERENCE TO RELATED APPLICATIONS

This application claims priority to Chinese Application No. 202010925619.9 filed Sep. 4, 2020. The contents from the above are hereby incorporated in their entirety by reference.

### TECHNICAL FIELD

The present invention relates to the technical field of liquidity maker, particularly relates to a decentralized token swap method with low slippage point and high liquidity.

### BACKGROUND

The blockchain industry has been developing rapidly in recent years, with thousands of blockchain assets/tokens being issued every year. The growth trend keeps rising and far from reaching its peak. It is anticipated that tens of millions of blockchain assets or more will co-exist (estimates assuming every company issues one blockchain asset). These blockchain assets, by its nature, are stored on their respective blockchain in a decentralized manner and users have strong demand for swapping or exchanging. Currently, the demand for blockchain assets trading are mainly implemented by centralized transaction platforms. Users have to transfer their decentralized assets on blockchain to centralized transaction platforms for management, and carry out transactions on the centralized transaction platforms in a way of maker bidding or gather bidding. There are some major concerns:

1. Users effectively lose their control over their blockchain assets, and the security of their assets will be threatened once an issue occurs in the centralized transaction platforms.

2. Centralized transaction platforms are limited in resources, and therefore, only capable of processing exchanges of a limited number of popular assets. For example, Gate.io, one of the world leading centralized transaction platforms and supports the most blockchain assets globally, only supports around 300 currencies and 500 trading pairs. The capability is still far behind the potentially required capability of processing tens of millions of assets in the future.

Decentralized swapping and transaction platforms can easily solve the two problems above simultaneously. However, decentralized transaction platforms have the following major problems:

1. As every single transaction needs to be verified and stored on each blockchain node, both of the processing and the storage logic must be simple enough to minimize the transaction cost. Therefore, the logic of orderbook and matching that used by traditional centralized transaction platforms do not suit well on decentralized exchanges. Some projects have adopted an approach of Offchain orderbook and matching, and Onchain transaction settlement to reduce the Onchain execution cost. However, this solution introduces other issues including poor degree of decentralization and trust crisis due to Offchain matchings are easily manipulated.

2. It also poses difficulties in respect of blockchain asset safety in storage. On a decentralized cryptocurrency exchange, individual users need to keep and store their own assets, their private keys are kept by themselves. Due to lacking of professional management experience and infrastructure of centralized platform, ordinary users are more vulnerable to hacking attacks. Furthermore, private keys that are stored by individual users are more likely to be destroyed and thus cannot recover their assets. To address this issue and reduce the hurdles for safe custody of decentralized assets, multi-signature hardware device and Onchain vault account are introduced by GateChain, so that individual users are able to safely store their blockchain assets in their own hands.

in 2017, a decentralized transaction protocol suitable to be implemented on Ethereum is proposed by Alen Lu, using constant product equation X*Y=k in a Ethereum smart contract to achieve automatic market maker for assets swapping or exchanging of X and Y. The Uniswap project implemented this approach and achieved huge success in the Defi upsurge in 2020. Such constant product equation can be popularized to general forms, for example, Balancer configures various assets with arbitrary weights and can automatically adjust the number of assets so as to maintain the ratio in assets values according to market price changes. It can provide swap services for pairwise assets, which is a more general implementation than Uniswap.

There are two defects in the decentralized Automated Market Marker implementation using constant product market maker (CPMM):

1. Impermanent loss. When there is price deviates, either increases or decreases, it incurs impermanent loss for the liquidity provider (LP). Such loss can only be recovered when the price returns to the original price when the LP deposits. This loss greatly reduces the enthusiasm of the LP in providing liquidity to the market. To address this issue, a high transaction fee of 0.3% is charged to the market Takers by Uniswap to reward the LP aiming to make up their impermanent losses. However, higher transaction fee in turn affects the motivation and enthusiasm of the market Takers.

2. High price slippage cost. When using a curve model like the constant product equation of X*Y=k, a high price slippage may occur for large volume transactions in particular, which would significantly increase the trading cost for Takers. A straight line model, such as X+Y=k, would eliminate such price slippage. However, the market price in this straight line model does not reflect the changes of demand and supply on the market. Curve.fi proposed a new model that combines both the curve model and the straight line model to effectively reduce the price slippage in stable asset swapping. However, this new model is not suitable for the swapping of nonstable assets.

In 2020, Bancor proposed a new method in its V2 version of decentralized asset swapping protocol, which uses an oracle machine to get market prices from centralized transactions and dynamically update the weight of LP to eliminate the impermanent losses. The V2 version reduces the price slippage by amplifying LP by 20 times. However, this method only fits into mainstream assets that have been listed on centralized exchanges and supported by an oracle machine. For new tokens and tokens with small market capital, it is difficult to get fast and comprehensive support from an oracle machine. Therefore, the scope of application of this method is greatly limited.

### BRIEF DESCRIPTION OF DRAWINGS

For a better understanding of the aforementioned embodiments as well as additional embodiments thereof, reference should be made to the Detailed Description below, in conjunction with the following drawing.

FIG. 1 illustrates a flowchart of a decentralized token swapping method with low slippage point and high liquidity, in accordance with some embodiments.

### SUMMARY OF INVENTION

The present invention aims to provide a decentralized method of swapping token with low slippage and high liquidity.

To implement the aforementioned purpose, the present invention provides the following technical solutions: a decentralized token swapping method with low slippage point and high liquidity, comprising:

providing liquidity to a liquidity pool by a liquidity provider, depositing a X token and a Y token into the liquidity pool in equal value ratio through mortgage;

providing liquidity to a X Maker Pool and a Y Maker Pool by a X maker and a Y maker independently;

wherein, the X Maker Pool records an amount of X token in the X Maker Pool, an amount of Y token in the X Maker Pool, a transaction fee rewarding pool of the X Maker Pool, an average swapping rate historically accumulated by the amount of Y token in the X Maker Pool, and an average token deposition time of the X maker in the X Maker Pool;

wherein the Y Maker Pool records an amount of Y token inf the Y Maker Pool, an amount of X token in the Y Maker Pool, a transaction fee rewarding pool of the Y Maker Pool; an average swapping rate historically accumulated by the amount of X token in the Y Maker Pool, and an average token deposition time of the Y maker;

when the X maker deposit X into the X Maker Pool, recording the deposited amount of X token and the time of the last X deposition through a contract account;

when the Y maker deposit Y into the Y Maker Pool, recording the deposited amount of Y token and the time of the last Y deposition through a contract account;

a Taker determines to swap from the liquidity pool or swap from the maker pools based on a random number.

Preferably, when the Taker swaps from the liquidity pool, a change in demand causes a fluctuation of the price, and a reasonable price is formed through the operation and competition from Takers in different directions; when the taker swaps from the X Maker Pool or the Y Maker Pool, the price is based on the current price of the liquidity pool, when the taker swaps Y for X, the amount of X token in the X Maker Pool decreases, the amount of Y token in the X Maker Pool increases, and in the meanwhile the transaction fee rewarding pool of the X Maker Pool is accumulated; when the taker swaps X for Y, the amount of Y token in the Y Maker Pool decreases, and the amount of X token in the Y Maker Pool increases, and in the meanwhile the transaction fee rewarding pool of the Y Maker Pool is accumulated.

Preferably, when the X maker deposits X into the X Maker Pool, and withdraws swapped currency Y form a Y pool in the X Maker Pool, the price is based on the average swapping rate historically accumulated by the amount of Y token of the X Maker Pool, a required transaction fee is related to the deposition time; wherein if the deposition time is less than the average token deposition time of the X maker, a transaction fee is required to be paid, and the transaction fee adds into the transaction fee rewarding pool of the X Maker Pool; herein if the deposition time is more than the average token deposition time of the X maker, a transaction fee is obtained, and the transaction fee is taken from the transaction fee rewarding pool of the X Maker Pool.

Preferably, when a value of the asset swapped and completed in the X Maker Pool or the Y Maker Pool is not as high as an off-site value, the X maker or the Y maker is replaced.

Preferably, the method further includes a timing module, and the time module starting a timing when the X Maker Pool or the Y Maker Pool is replaced, when the timing of the time module is less than a preset minimum duration, the X Maker Pool or the Y Maker Pool is not allowed to be replaced, when the timing of the time module is larger than the preset minimum duration, the X maker or the Y maker is allowed to trigger a switch.

Preferably, when the swapping in one of the mark pools reaches a predetermined ratio, and when a next maker starts to perform deposition, the mark pool is switched to a new mark pool, the newly deposited X or Y is automatically deposited in to the new mark pool, and the average swapping rate is re-accumulated again, and the makers who deposited X or Y into the previous mark pool can only withdraw X or Y from the previous mark pool.

Preferably, the predetermined ratio is 90%.

The present invention offers technical advantages over the existing technology, including:

The invention can effectively reduce the swapping slippage: if the leverage rate is n, then the slippage can be reduced to 1/n of the Uniswap mode.

More demand is provided. Users who plan to sell one asset for another over a period of time can provide liquidity, rather than only rely on users in an equal proportion mortgage to provide liquidity.

### DETAILED DESCRIPTION

The technical solutions in the embodiments of the present invention will be clearly and completely described below, and obviously, the described embodiments are only part of the embodiments of the present invention, and not all embodiments.

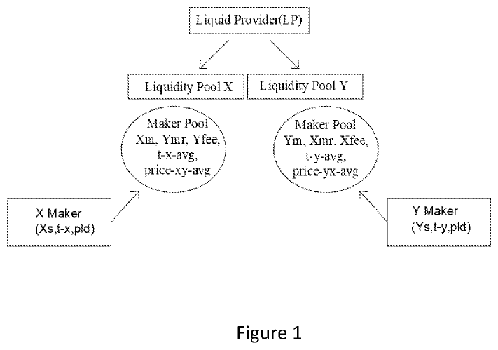

FIG. 1 illustrates a flowchart of a decentralized token swapping method with low slippage point and high liquidity, in accordance with some embodiments. The decentralized token swapping method includes the following steps:

providing liquidity to a liquidity pool by a liquidity provider, depositing a X token and a Y token into the liquidity pool in equal value ratio through mortgage;

providing liquidity to a X Maker Pool and a Y Maker Pool by a X maker and a Y maker independently;

wherein, the X Maker Pool records an amount of X token in the X Maker Pool, an amount of Y token in the X Maker Pool, a transaction fee rewarding pool of the X Maker Pool, an average swapping rate historically accumulated by the amount of Y token in the X Maker Pool, and an average token deposition time of the X maker in the X Maker Pool;

wherein the Y Maker Pool records an amount of Y token in the Y Maker Pool, an amount of X token in the Y Maker Pool, a transaction fee rewarding pool of the Y Maker Pool; an average swapping rate historically accumulated by the amount of X token in the Y Maker Pool, and an average token deposition time of the Y maker;

when the X maker deposit X into the X Maker Pool, recording the deposited amount of X token and the time of the last X deposition through a contract account;

when the Y maker deposit Y into the Y Maker Pool, recording the deposited amount of Y token and the time of the last Y deposition through a contract account;

a Taker determines to swap from the liquidity pool or swap from the maker pools based on a random number.

When the Taker swaps from the liquidity pool, a change in demand causes a fluctuation of the price, and a reasonable price is formed through the operation and competition from Takers in different directions; when the taker swaps from the X Maker Pool or the Y Maker Pool, the price is based on the current price of the liquidity pool, when the taker swaps Y for X, the amount of X token in the X Maker Pool decreases, the amount of Y token in the X Maker Pool increases, and in the meanwhile the transaction fee rewarding pool of the X Maker Pool is accumulated;

When the taker swaps X for Y, the amount of Y token in the Y Maker Pool decreases, and the amount of X token in the Y Maker Pool increases, and in the meanwhile the transaction fee rewarding pool of the Y Maker Pool is accumulated.

When the X maker deposits X into the X Maker Pool, and withdraws swapped currency Y form a Y pool in the X Maker Pool, the price is based on the average swapping rate historically accumulated by the amount of Y token in the X Maker Pool, a required transaction fee is related to the deposition time; wherein if the deposition time is less than the average token deposition time of the X maker, a transaction fee is required to be paid, and the transaction fee adds into the transaction fee rewarding pool of the X Maker Pool; herein if the deposition time is more than the average token deposition time of the X maker, a transaction fee is obtained, and the transaction fee is taken from the transaction fee rewarding pool of the X Maker Pool.

When a value of the asset swapped and completed in the X Maker Pool or the Y Maker Pool is not as high as an off-site value, the X maker or the Y maker is replaced.

The method further includes a timing module, and the time module starting a timing when the X Maker Pool or the Y Maker Pool is replaced, when the timing of the time module is less than a preset minimum duration, the X Maker Pool or the Y Maker Pool is not allowed to be replaced, when the timing of the time module is larger than the preset minimum duration, the X maker or the Y maker is allowed to trigger a switch.

When the swapping in one of the mark pools reaches 90%, and when a next maker starts to perform deposition, the mark pool is switched to a new mark pool, the newly deposited X or Y is automatically deposited in to the new mark pool, and the average swapping rate is re-accumulated again, and the makers who deposited X or Y into the previous mark pool can only withdraw X or Y from the previous mark pool.

The process is described in detail below. Firstly, there are four liquidity pools.

Liquidity Pool: reserves the stored X-Y assets from LP for staking while maintaining their ratio relation in market value ratio

Maker Pool X: includes X assets deposited by X maker, total amount Xm, Y assets Ymr which are swapped back, and collected Y currency maker fee Yfee.

Maker Pool Y: includes Y assets deposited by Y Maker, total amount Ym, X assets Xmr which are swapped back, and collected X currency maker fee Xfee.

There are also market participants, which are divided into four types below.

Liquidity Provider: users who lock their holdings to yield interests or earning. Liquidity Provider supports liquidity and price discovery for CPMM through depositing two tokens (or more) to liquidity Pool in equal value ratio by means of a mortgage. Liquidity Provider obtains some earnings from Taker, but need to suffer Impermanent Loss.

X Maker: users who want to sell asset X for asset Y. These users would deposit asset X into a X Maker Pool. The deposited asset X will be swapped automatically for asset Y over a period of time according to the market price. This process would take a period of time to complete, which is about 12 hours for active trading pairs accordingly to analysis on Uniswap. The market price is calculated based on the CPMM price at the time when a transaction is initiated by Taker.

When asset X is deposited into the X Maker Pool by X Maker, two values (Xs, t_x) will be stored in a contract account, wherein Xs refers to X sent and is the amount of asset X being deposited; and t_x refers to the last deposit time and is used to calculate transaction fee for withdrawing. Users can withdraw Xs from the contract account or Y that has been completely converted to his wallet at any time.

Y Market Maker: users who want to sell asset Y for asset X. They deposit asset Y into Y Maker Pool. The deposited asset Y will be swapped automatically for asset X over a period of time using market price. The converting process does take some time to complete.

When asset Y is deposited into the Y Maker Pool by Y Maker, two values (Ys, t_y) will be stored in a contract account, wherein Ys refers to Y sent and is the amount of Y being deposited. T_y refers to the last deposition time.

Taker: a requestor initiates a swapping request actively.

Below are definitions of some operations (here we use the x*y=k model from Uniswap as an example, a Balancer model can also be used):

Liquid Provider Adds Liquidity: add Liquidity (Δx), where asset X and asset Y are added to Liquidity Pool at the same rate:

X′=X*(1+α)

Y′=Y*(1+α)

α=Δx/X

Liquid Provider Removes Liquidity: remove Liquidity (Δx), where asset X and asset Y are removed from Liquidity Pool at the same rate:

X′=X*(1−α)

Y′=Y*(1−α)

α=Δx/X

X Maker increases liquidity: XMakerDeposit (Δx), Xm in X Maker Pool increases, and simultaneously modifies debt and latest deposit time (Xs, t_x) of the user. If any asset X was deposited before and has not been withdrawn, the previous deposit time will be overwritten with the current deposit time and the reward of transaction fee will be affected. It should be noted that as there may be several X Maker Pools co-existing at the same time, the latest Pool Id will be retrieved and used to settle new deposits. If a user's current Pool Id is not the latest, a mandatory liquidation according to the default ratio will be performed for the users in the old pool, before allowing any depositing to the new pool.

P_{Id}=Current Pool Id

Xm′(P_{Id})=Xm(P_{Id})+Δx

Xs′=Xs+Δx

tₓ′=current time

Create New Pool: Before depositing Δx to X Maker Pool, a check will be performed to determine whether a new Maker Pool needs to be created. When the ratio of the value of uncompleted X to the value of completed Ymr in the X Maker Pool is less than 1:9, it is considered that a new X Maker Pool is needed. A minimum duration will be configured in order to avoid frequent switching or accidental switching due to some special circumstances. For example, a Maker Pool must be used for at least 30 minutes (or the corresponding average number of blocks) before triggering the switch.

if (Xm's value<1/9 Ymr's value):Current X Pool Id+=1

X Maker Withdraw liquidity: XMakerWithDraw(Δx, Δy) does not need to be reduced in a same ratio. A market maker can withdraw only one asset, or withdraw both part of asset X and asset Y in the same transaction. Both Xm and Ymr in Maker Pool X should be reduced and the debit record (Xs) in the contract also needs to be reduced. Xs cannot be less than 0. Since token swapping is not required when asset X is withdrawn, neither transaction cost nor rewarding are provided. However, a time based transaction cost will be charged when asset Y is withdrawn from Ymr, and the price will be calculated based on the historically accumulated average swapping price of Ymr (price_xy_avg). If the deposit duration is less than the average duration of Maker deposition time in the pool, a transaction fee is charged and will be added to Yfee. If the deposit duration is longer than the average duration of Maker deposition time in the pool, a rebate will be rewarded which is taken from Yfee. Please note, the assets must be withdrawn from the Maker Pool according to the Pool Id which matches with the record in the X Maker's account. However, this Pool Id may not always be the latest Maker Pool.

Calculate the total debt to be deducted from the market maker:

Δx′=price_xy_avg*Δy+Δx

Here is the procedure of deduction calculation and withdrawal operations:

Xm′(P_{Id})=Xm(P_{Id})−Δx′

Xs′=Xs−Δx′; only if Δx′<=Xs

Ymr′(P_{Id})=Ymr(P_{Id})−Δy

Yr′=Yr−Δy; only if Δy<=Yr

For the case where Δx and Δy are not specified, both Δx and Δy will be calculated by the completed swapped ratio in the X Maker Pool as:

σ=Xm/(Xm+price_xy_avg *Ymr)

(It may be required to consider pre-redemption or post-redemption calculation, followed by careful evaluation later.)

The total debt to be deducted from the market maker can be calculated as such:

ΔX=σXs

Δy=(1−σ)Xs*price_xy_avg

Δx′=Xs

The following procedures of deduction calculation are same as the withdrawal operations:

Xm′(P_{Id})=Xm(P_{Id})−Δx′

Xs′=Xs−Δx′; only if Δx′<=Xs

Ymr′(P_{Id})=Ymr(P_{Id})−Δy

Yr′=Yr−Δy; only if Δy<=Yr

Y Maker increases liquidity: YMakerDeposit(Δy), Ym at Y Maker Pool increases, and simultaneously modifies debt and latest deposition time (Ys, t_y) of the user. If any asset Y was deposited before and has not been withdrawn, the previous deposit time will be overwritten with the current deposit time and the reward of transaction fee will be affected. Please note that as there may be several Y Maker Pools co-existing at the same time, the latest Pool Id will be retrieved and used to settle new deposits. If a user's current Pool Id is not the latest, a mandatory liquidation according to the default ratio will be performed for the users in the old pool before allowing any depositing to the new pool. Pleased be noted that Current X Pool Id and Current Y Pool ID may not be the same, and therefore cannot be replaced by the same variable.

P_{Id}=Current Y Pool Id

Ym′(P_{Id})=Ym(P_{Id})+Δy

Ys′=Ys+Δy

ty′=current time

Create New Pool: Before depositing Δy to Y Maker Pool, a check will be performed to determine whether a new Y Maker Pool needs to be created. When the ratio of the value of uncompleted Y to the value of completed Xmr in the Y Maker Pool is less than 1:9, it is considered that a new Y Maker Pool is needed. A minimum duration will be configured in order to avoid frequent switching or accidental switching due to some special circumstances. For example, a Maker Pool must be used for at least 30 minutes (or the corresponding average number of blocks) before triggering the switching.

if (Ym's value<1/9 Xmr's value):Current Y Pool Id+=1

Y Maker Withdraw liquidity: YMakerWithdraw(Δy, Δx) does not need to be reduced in a same ratio. A market maker can withdraw only one asset, or both part of asset X and asset Y in the same transaction. Both Ym and Xmr in the Y maker Pool should be reduced and the debt record (Ys) in the contracts also needs to be deducted. Ys cannot be less than 0. Since token swapping is not required when asset Y is withdrawn, neither transaction cost nor rewarding is are provided. However, a time based transaction cost will be charged when asset X is withdrawn from Xmr, and the price will be calculated based on the historically accumulated average swapping price of Xmr (price_yx_avg). If the deposit duration is less than the average duration Maker deposition time in the pool, a transaction fee is charged and will be added to Xfee. If the deposit duration is longer than the average duration of Maker deposition time in the pool, a rebate will be rewarded which is taken from Xfee. Please note, the assets must be withdrawn from the Maker Pool according to the Pool Id which matches with the record in the Y Maker's account. However, this Pool Id may not always be the latest Maker Pool.

Calculate the total debt to be deducted from the market maker:

Δy′=price_yx_avg*Δx+Δy

Here is the procedure of deduction calculation and withdrawal operations:

Ym′(P_{Id})=Ym(P_{Id})−Δy′

Ys′=Ys−Δy′; only if Δy′<=Ys

Xmr′(P_{Id})=Xmr(P_{Id})−Δx

Xr′=Xr−Δx; only if Δx<=Xr

For the case where Δx and Δy are not specified, both Δx and Δy will be calculated by the completed swapped ration in the Y Maker Pool as:

σ=Ym/(Ym+price_yx_avg*Xmr)

Therefore the total debt to be deducted from the market maker can be calculated as such:

Δy=σYs

Δx=(1−σ)Ys*price_yx_avg

Δy′=Ys

(It may be required to consider pre-redemption or post-redemption calculation, followed by careful evaluation later.)

The total debt to be deducted from the market maker can be calculated as such:

Δy=σys

Δx=(1−σ)Ys*price_yx_avg

Δy′=Ys

The following procedures of deduction calculation are same as the withdrawal operations:

Ym′(P_{Id})=Ym(P_{Id})−Δy′

Ys′=Ys−Δy′; only if Δy′<=Ys

Xmr′(P_{Id})=Xmr(P_{Id})−Δx

Xr′=Xr−Δx; only if Δx<=Xr

Taker Withdraw Liquidity

The leverage factor=n. Theoretically, the proportion of quantity withdrawn from the Liquidity Pool=rₛ=1/n, and the proportion of quantity withdrawn from Maker Pool=rₘ=1−1/n;

where γ=1−ρ and ρ is the Taker transaction fee.

The amount of X input by Taker=Δx, the amount of swapped Y=Δy

The current price in Liquidity Pool is p=x/y

At first, obtain Y from Y Maker Pool, the amount obtained is (transaction fee included):

Δy₁=Min(Δx/ρ*rₘ, Ym)*γ

The amount of swapped X is:

Δx₁=ρ*Δy₁/γ

The remaining amount of X to be swapped is:

Δx₂=Δx−Δx₁

The remaining amount should be totally swapped from the Liquidity Pool (same behaviour as Uniswap):

Δy₂=αγ/(1+αγ)*y

α=Δx₂/x

Update the amount of Y Maker Pool:

Ym′=Ym−ΔY₁/γ

Xmr′=Xmr+Δx₁

price_yx_avg′=(price_yx_avg*Xmr+Δy₁)/(Zmr+Δx₁)

Update the amount in the Liquidity Pool, as the following:

Y′=Y+Δy₂/γ

X′=X+Δx₂

The amount of Y input by Taker=Δy, the amount of swapped X=Δx. The latest swapping price in Liquidity Pool is p=x/y

At first, obtain X from X Maker Pool, the amount obtained is (transaction fee included):

Δx₁=Min(Δy*ρ*rₘ, Xm)*γ

The amount of swapped Y is:

Δy₁=Δx₁/ρ/γ

The remaining amount of Y to be swapped is:

Δy₂=Δy−Δy₁

The remaining amount should be totally swapped from the Liquidity Pool (same behaviour as Uniswap):

Δx₂=β/(1−β)*(1/γ)*x

β=Δy₂/Y

Update the amount of Y Maker Pool as the following:

Xm′=Xm−Δx₁/γ

Ymr′=Ymr+Δy₁

price_xy_avg′=(price_xy_avg*Ymr+Δx₁)/(Ymr+Δy₁)

Update the amount in the Liquidity Pool as the following:

X′=X+Δx₂/γ

Y′=Y+Δy₂

Add a separate interface to trigger the creation of new X Maker Pool. This separate interface is optional. However, when there is no Maker-initiated creation of new Maker Pool, any Good Samaritan can trigger the creation.

When the creation request of new X Maker Pool is received, the system must verify whether the ratio of the value of uncompleted X to the value of completed Ymr is less than 1:9 before processing it. If yes, it is considered that a new X Maker Pool is needed. Otherwise, no action will be taken:

if (Xm's value<1/9 Ymr's value):Current X Pool Id+=1

Add a separate interface to trigger the creation of new Y Maker Pool. This separate interface is optional. However, when there is no Maker-initiated creation of new Maker Pool, any Good Samaritan can trigger the creation. When the creation request of new Y Maker Pool is received, the system must verify whether the ratio of the value of uncompleted Y to the value of completed Xmr is less than 1:9 before processing it. If yes, it is considered that a new Y Maker Pool is needed. Otherwise, no action will be taken:

if (Ym's value<1/9 Xmr's value):Current Y Pool Id+=1

The present method integrates a CPMM (Constant product market makers) protocol similar to the one implemented in Uniswap, which can automatically discover market price without relying on the price feeds from an oracle machine. However, the Uniswap protocol does not have an interface for market makers, except for the liquidity provider; therefore, all the other buyers and sellers using Uniswap protocol are forced to be market takers. This will result in higher price slippage for large-volume traders. The present method offers a new channel for the users to act as the Maker, so that better market liquidity could be provided by those large-volume traders who are not in a demand for immediate executions. In this way, market makers will not only effectively reduce their price slippage, but also earn trading fee rebate from market takers via providing market liquidity. Furthermore, this protocol also significantly reduces the trading cost for market makers, when price fluctuation is not taking into consideration. Meanwhile, due to the existence of the Maker, who enable the possibility for the Taker to get liquidity from both the CPMM Liquidity Pool and through direct transaction with the Maker Pool, the price slippage will be effectively reduced. In the case of equal CPMM LP liquidity and sufficient liquidity in the Maker Pool, with the leverage of 10×, the Taker's price slippage could be reduced to 1/10 comparing with that only using the CPMM Liquidity Pool. In order to compensate for the impermanent loss of LP, Uniswap charges a high transaction fee of 0.3% from market takers and results in high transaction costs for the users. In the HipoSwap protocol, different rates can be set to optimize the overall fees for Taker. For example, a 0.35% transaction fee could be charged for the amount directly swapped from the Liquidity Pool and used as a reward for liquidity providers to increase their enthusiasm; and a 0.15% transaction fee could be charged for amount directly swapped from the Maker Pool, to reduce the cost for Taker. As majority of the transactions from market Taker would be handled directly by the Maker Pool, such proposed fee structure would significantly reduce the overall trading cost for market takers. Ideally, assuming 90% of the amount is swapped from the Maker Pool, the average trading fee could be reduced to as low as 0.17%.

The operating mechanism of the Liquidity Pool implemented in the method is consistent with the Uniswap protocol and the Balancer protocol. When processing operations from the market Taker, the smart contract on Uniswap or Balancer protocol could be invoked via msg to facilitate the token swap and to retrieve the latest prices; operations from the Maker Pool will only be processed subsequently. This mechanism is designed to fully utilize the market liquidity provided by the Liquidity Pool in Uniswap.

The Liquidity Pool does not have to keep the value ratio at 1:1 as Uniswap. The value ratio can be set in any ratio like Balancer.

The present method can be implemented and deployed on different blockchains. It can be implemented on Ethereum and Tron networks using Smart Contracts. It can also be implemented on GateChain using native codes. The implementation on GateChain could combine the features of both the Regular Account and the Vault Account provided by GateChain that store commonly used funds in the Regular account and infrequently used large amount of funds in the Vault account, to balance the transaction demand and security requirements of users.

It is understood to those skilled in the art that the invention is not limited to the details of the embodiments, and that the present invention may be embodied in other specific forms without departing from the spirit or essential attributes thereof. The present embodiments are therefore to be considered in all respects as illustrative and not restrictive. The scope of the invention is indicated by the appended claims rather than by the foregoing description, and all changes which come within the meaning and range of equivalency of the claims are therefore intended to be embraced therein.

1. A decentralized token swapping method with low slippage point and high liquidity, characterised in that the method comprises the following steps:
providing liquidity to a liquidity pool by a liquidity provider, depositing a X token and a Y token into the liquidity pool in equal value ratio through mortgage;
providing liquidity to a X Maker Pool and a Y Maker Pool by a X maker and a Y maker independently;
wherein, the X Maker Pool records the amount of X token in the X Maker Pool, an amount of Y token in the X Maker Pool, a transaction fee rewarding pool of the X Maker Pool, an average swapping rate historically accumulated by the amount of Y token in the X Maker Pool, and an average token deposition time of the X maker in the X Maker Pool;
wherein the Y Maker Pool records the amount of Y token in the Y Maker Pool, an amount of X token in the Y Maker Pool, a transaction fee rewarding pool of the Y Maker Pool; an average swapping rate historically accumulated by the amount of X token in the Y Maker Pool, and an average token deposition time of the Y maker;
when the X maker deposit X token into the X Maker Pool, recording the deposited amount of X token and the time of the last X deposition through a contract account;
when the Y maker deposit Y token into the Y Maker Pool, recording the deposited amount of Y token and the time of the last Y deposition through a contract account;
a Taker determines to swap from the liquidity pool or swap from the maker pools based on a random number.

2. The decentralized token swapping method with low slippage point and high liquidity according to claim 1, characterized in that,
when the Taker swaps from the liquidity pool, a change in demand causes a fluctuation of the price, and a reasonable price is formed through the operation and competition from Takers in different directions;
when the taker swaps from the X Maker Pool or the Y Maker Pool, the price is based on the current price of the liquidity pool,
when the taker swaps Y for X, the amount of X token in the X Maker Pool decreases, the amount of Y token in the X Maker Pool increases, and in the meanwhile the transaction fee rewarding pool of the X Maker Pool is accumulated;
when the taker swaps X for Y, the amount of Y token in the Y Maker Pool decreases, and the amount of X token in the Y Maker Pool increases, and in the meanwhile the transaction fee rewarding pool of the Y Maker Pool is accumulated.

3. The decentralized token swapping method with low slippage point and high liquidity according to claim 2, characterized in that:
when the X maker deposits X into the X Maker Pool, and withdraws swapped currency Y form a Y pool in the X Maker Pool, the price is based on the average swapping rate historically accumulated by the amount of Y token in the X Maker Pool, a required transaction fee is related to the deposition time;
wherein if the deposition time is less than the average token deposition time of the X maker, a transaction fee is required to be paid, and the transaction fee adds into the transaction fee rewarding pool of the X Maker Pool;
wherein if the deposition time is more than the average token deposition time of the X maker, a transaction fee is obtained, and the transaction fee is taken from the transaction fee rewarding pool of the X Maker Pool.

4. The decentralized token swapping method with low slippage point and high liquidity according to claim 3, characterized in that:
when a value of the asset swapped and completed in the X Maker Pool or the Y Maker Pool is not as high as an off-site value, the X maker or the Y maker is replaced.

5. The decentralized token swapping method with low slippage point and high liquidity according to claim 4, characterized in that:
the method further includes a timing module, and the time module starting a timing when the X Maker Pool or the Y Maker Pool is replaced,
when the timing of the time module is less than a preset minimum duration, the X Maker Pool or the Y Maker Pool is not allowed to be replaced,
when the timing of the time module is larger than the preset minimum duration, the X maker or the Y maker is allowed to trigger a switch.

6. The decentralized token swapping method with low slippage point and high liquidity according to claim 5, characterized in that:
when the swapping in one of the mark pools reaches a predetermined ratio, and when a next maker starts to perform deposition, the mark pool is switched to a new mark pool, the newly deposited X or Y is automatically deposited in to the new mark pool, and the average swapping rate is re-accumulated again,
and the makers who deposited X or Y into the previous mark pool can only withdraw X or Y from the previous mark pool.

7. The decentralized token swapping method with low slippage point and high liquidity according to claim 6, characterized in that: the predetermined ratio is 90%.
